(19) United States
(12) Patent Application Publication
(10) Pub. No.: US 2026/0292956 A1
(43) Pub. Date: Sep. 24, 2026

(54) METHOD FOR CONTROLLING A LIGHTING DEVICE AND RELATED LIGHTING SYSTEM

(71) Applicant: SIGNIFY HOLDING B.V., EINDHOVEN (NL)

(72) Inventors: DRAGAN SEKULOVSKI, EINDHOVEN (NL); AARON BENJAMIN STEPHAN, CHANHASSEN, MN (US); MARC ANDRE DE SAMBER, LOMMEL (BE)

(21) Appl. No.: 19/473,714

(22) PCT Filed: Mar. 28, 2024
(86) PCT No.: PCT/EP2024/058436

§ 371 Date: Oct. 8, 2025

Related U.S. Application Data
(60) Provisional application No. 63/458,206, filed on Apr. 10, 2023.

(30) Foreign Application Priority Data
Apr. 18, 2023 (EP) 23168393.9

(51) Int. Cl. H05B 47/105

(52) U.S. Cl. CPC H05B 47/105

(57) ABSTRACT

A method for controlling a lighting device (2) is disclosed, the lighting device (2) being configured to emit device light and being controllable at least with respect to the light spectrum of the device light (3). A specification of a target light spectrum is obtained. Based on first information regarding sensitivity of first receptors in an eye of a first, non-human animal (5) in dependency of wavelength, spectral responses of the first receptors for the wavelengths of the target light spectrum are determined. The light spectrum of the device light (3) is controlled such that the spectral responses of the first receptors for the wavelengths of the light spectrum of the device light (3) become the same, or at least comparable to, the spectral responses of the first receptors for the wavelengths of the target light spectrum. A related lighting system (1) is also disclosed.

### TECHNICAL FIELD

The present invention relates to a method for controlling a lighting device and a related lighting system, the lighting device being configured to emit device light and being controllable at least with respect to the light spectrum of the device light. The present invention further relates to a related lighting system.

### BACKGROUND

Controlling of lighting is often carried out in view of the limitations of a light generating system, and not in view of the requirements of the user, or viewer. For example, white light may be generated by mixing the output of multiple light sources emitting light in different wavelength ranges, for example by mixing the output of light-emitting diodes (LEDs), such as, for example, nominally red-, green- and blue-emitting LEDs. Each of the light sources emitting light in different wavelength ranges, such as for example nominally red-, green- and blue-emitting LEDs, may be referred to as a primary. The output of each of the primaries may often be controlled independently. Therefore, multi-primary lighting systems, e.g., based on LEDs, may be capable of emitting light in a wide range of spectral power distributions. In case of relatively complex, multi-primary lighting systems, the controlling is often carried out in the device color space, e.g., by directly controlling the intensity level of each primary. Some light generating systems may allow for the specification of the required light output using a device independent color space (e.g., CIE XYZ or derived) and derived parameters (like Correlated Color Temperature, CCT). Other lighting systems may allow for matching of a target spectrum, either directly trying to reproduce the spectrum, or a sensory match for a human user/viewer.

US2010/188022A1 discloses a method of matching a composite light spectrum to a target light spectrum. The method comprises providing a light emitting diode (LED) array, the LED array comprising emitters having four or more distinct dominant wavelengths within visible spectrum for generating an output composite light spectrum. Furthermore, a difference between CIE chromaticity coordinates of the target light spectrum and the composite light spectrum is minimized while simultaneously maximizing luminous output of the LED array.

### SUMMARY

The units used to measure or characterize light are generally human centric, or human specific. A reason for this is the phenomenon of metamerism, i.e., the fact that many electromagnetic spectra result in the same visual sensation. Although an arbitrary electromagnetic spectrum cannot be faithfully represented with a finite number of numbers, the sensory sensation can be faithfully represented with a finite number of numbers. For humans, the sensory sensation is usually represented by a set of three numbers, because human color vision is based on three independent types of color receptors. While humans have three types of color receptors (or photoreceptors) in the eyes, which is called trichromacy, this is not always the case for other animal species, and in fact trichromacy is quite rare among animal species. Most vertebrates have four types of color receptors in the eyes (in which case they are called tetrachromats) or more than four types of color receptors in the eyes. An exception is mammals which mostly have two different types of color receptors in the eyes (in which case they are called dichromats). The number of types of color receptors in the eyes may not be the only difference among different animal species. Different animal species with the same number of types of color receptors in the eyes may have maximum sensitivity (or spectral response) of the color receptors at different wavelengths, and the optical properties of the eyes themselves can be different between different animal species. For example, in birds, oil droplets with a selective transmission are present in the optical pathway in the cones, via which optical pathway photons are transported to the photopigments on the retina of the eyes, sharpening the spectral response of the cones. Among invertebrates, the variability of sensitivities may be even larger. Another aspect of color vision is light adaptation. Many spectra with a different intensity, but the same spectral power distribution will result in the same sensory output of the visual system. Thus, when computing equal sensory activation, in the context of the present application, both absolute sensory activation and relative sensory activation may be used. An equality in relative sensory activation is understood to be the equality of the ratios of the responses of the photoreceptors. The range of illuminance for which only the relative sensory response for the animal can be taken into account is animal dependent, and for humans it ranges from about 5 lux to about 500000 lux.

Agriculture is changing in many different aspects, for example in relation to lighting. Lighting systems used in agriculture are becoming increasingly advanced, and the controlling of the lighting systems is becoming increasingly powerful by the use of advanced models and artificial intelligence, such as in horticulture and animal husbandry. However, the complexities of the different visual systems of animals, such as the vision of livestock and the vision of pollinators and biological pest control, are largely ignored.

In view of the above, a concern of the present invention is to provide a method for controlling a lighting device, which lighting device is configured to emit device light and being controllable at least with respect to the light spectrum of the device light, which method facilitates for or allows to tailor the device light to a non-human animal, or a set of non-human animals.

To address at least one of this concern and other concerns, a method for controlling a lighting device and a lighting system in accordance with the independent claims are provided. Preferred embodiments are defined by the dependent claims.

According to a first aspect, a method for controlling a lighting device is provided. The lighting device is configured to emit device light and is controllable at least with respect to the light spectrum of the device light. The method comprises obtaining a specification of a target light spectrum. Based on first information regarding sensitivity of first receptors in an eye of a first animal as a function of wavelength, spectral responses of the first receptors for the wavelengths of the target light spectrum are determined. The first animal is non-human. The light spectrum of the device light is controlled such that the determined spectral responses of the first receptors for the wavelengths of the light spectrum of the device light become the same, or at least comparable to, the determined spectral responses of the first receptors for the wavelengths of the target light spectrum. The wording “becomes the same, or at least becomes comparable to” particularly means that the calculated difference between the determined spectral responses of the first receptors for the wavelengths of the light spectrum of the device light and the determined spectral responses of the first receptors for the wavelengths of the target light spectrum is minimized.

According to a second aspect, a lighting system is provided. The lighting system comprises a lighting device configured to emit device light and being controllable at least with respect to the light spectrum of the device light, and a control and processing unit. The control and processing unit is configured to obtain a specification of a target light spectrum. The control and processing unit is configured to, based on first information regarding sensitivity of first receptors in an eye of a first animal as a function of wavelength, determine spectral responses of the first receptors for the wavelengths of the target light spectrum. The first animal is non-human. The control and processing unit is configured to control the light spectrum of the device light such that the determined spectral responses of the first receptors for the wavelengths of the light spectrum of the device light become the same, or at least comparable to, the determined spectral responses of the first receptors for the wavelengths of the target light spectrum. The wording “becomes the same, or at least becomes comparable to” particularly means that the calculated difference between the determined spectral responses of the first receptors for the wavelengths of the light spectrum of the device light and the determined spectral responses of the first receptors for the wavelengths of the target light spectrum is minimized.

According to a third aspect, a computer program product is provided. The computer program product comprises instructions which, when executed by one or more processors of a control and processing unit of a lighting system according to the second aspect, cause the control unit and processing to carry out a method according to the first aspect.

Particularly, controlling the light spectrum of the device light comprises minimizing the calculated difference between the determined spectral responses of the first receptors for the wavelengths of the light spectrum of the device light and the determined spectral responses of the first receptors for the wavelengths of the target light spectrum. In an embodiment, the calculated difference is minimized below a specified threshold value. In an embodiment, a control signal is determined based on said calculated minimized difference, and wherein the control signal is used to control the lighting device for generating the determined light spectrum that provides said calculated minimized difference between the determined spectral responses of the first receptors for the wavelengths of the light spectrum of the device light and the determined spectral responses of the first receptors for the wavelengths of the target light spectrum.

In an embodiment, the target light spectrum is a white light spectrum, wherein the white light has a correlated color temperature (CCT) between about 2000-7000 K, such as in the range of 2700 K and 6500 K. In embodiments the correlated color temperature (CCT) of the white light is especially within about 15 SDCM (standard deviation of color matching) from the BBL (black body locus), especially within about 10 SDCM from the BBL, even more especially within about 5 SDCM from the BBL. In embodiments, the color rendering index (CRI) of the white light is at least 70, preferably at least 80. In an embodiment, the light spectrum that is determined based on minimizing the calculated difference between the determined spectral responses of the first receptors for the wavelengths of the light spectrum of the device light and the determined spectral responses of the first receptors for the wavelengths of the target light spectrum, is a light spectrum configured for illuminating animals in an agricultural environment, and said light spectrum is for example based on a target light spectrum that is a white light spectrum. Examples of an agricultural environment are a barn or a coop for housing animals.

As mentioned, the first animal is non-human. For example, the first animal may be a livestock animal (e.g., a pig, a cow, a chicken, etc.), or a household pet (e.g., a cat, a dog, etc.). It is noted that these are non-limiting examples of the first animal. According to other examples, which may be particularly relevant in horticulture, the first animal may be a pollinator, or an animal used or usable for biological pest control.

Thus, by means of embodiments of the present invention, it may be facilitated for or allowed to tailor the device light to a non-human animal, or a set of non-human animals.

In addition to livestock animal or household animal applications and horticulture applications, embodiments of the present invention may be employed in other applications, such as, for example, aquaculture.

The target light spectrum may for example be a light spectrum of, or comparable to, a black body radiator at a certain temperature, such as, for example, 4000 K, but is not limited thereto.

In the context of the present application, sensitivity of receptors (e.g., first receptors) in an eye of an animal (e.g., a first animal) in dependency of wavelength may mean or refer to a measure of how likely the receptors are to produce a response to light incident on the eye (and the receptors) in dependency of wavelength. The term “sensitivity” and spectral sensitivity” may be used interchangeably. It is to be understood that the spectral responses of the receptors (e.g., first receptors) might also include the influence of the pre-receptoral filtering resulting from the properties of the optical elements in the eye of the animal (e.g., the first animal) that are in the optical path to the photopigments in the receptors.

By controlling the light spectrum of the device light such that the spectral responses of the first receptors for the wavelengths of the light spectrum of the device light become the same, or at least comparable to, the spectral responses of the first receptors for the wavelengths of the target light spectrum, savings in energy consumption by the lighting device may be achieved. This is due to that the light spectrum of the device light may only need to correspond to a ‘portion’ of the complete target light spectrum and still result in the same visual sensation or perception for the first animal as if the device light would correspond to the complete target light spectrum.

Controlling the light spectrum of the device light may entail determining (e.g., by the control and processing unit) light transmission settings for the lighting device.

According to one implementation example for illustrating one or more embodiments of the present invention, the lighting device may comprise a multichannel light source and the control and processing unit may determine operational settings, e.g., light transmission settings, for the lighting device. The multichannel light source could for example comprise at least two independently controlled light sources capable of outputting light with different spectral compositions. The determination may be carried out based on a target light spectrum, which for example may be, or be comparable to, a 4000 K black body radiator, and cone photoreceptor sensitivities of the first animal, which for example may be a pig. Based on the information regarding the target light spectrum and the cone photoreceptor sensitivities of the first animal, the relative spectral activation of the cone photoreceptors of the first animal for the wavelengths of the target light spectrum may be determined (e.g., calculated), and then the operational settings may be determined such that the same spectral activation of the cone photoreceptors is obtained by the device light. This may allow for savings in energy consumption by the lighting device, because the complete black body radiator light spectrum may not need to be provided in the light output by the lighting device for achieving the same visual sensation or perception by the first animal.

As mentioned, the first animal may for example be a pig. Compared to pigs, humans can see deeper into red light, and humans have three types of cone photoreceptors compared to the two types of cone photoreceptors of the pig. The relative spectral activation of the cone photoreceptors of the first animal (e.g., the pig) for the wavelengths of the target light spectrum may for example be determined (e.g., calculated) by convolving the target light spectrum with the cone photoreceptor sensitivities of the first animal, i.e., by determining a convolution between target light spectrum and the cone photoreceptor sensitivities of the first animal.

As an example, the lighting device could comprise a multichannel light source with three primaries emitting light in the red, blue and green wavelength ranges, respectively. In that case, determining (e.g., calculating) relative spectral activation of the cone photoreceptors of the first animal for the wavelengths of the target light spectrum and determining the operational settings of the lighting device such that the same spectral activation of the cone photoreceptors is obtained by the device light, may involve determining (e.g., calculating) relative spectral activation of the cone photoreceptors of the first animal (e.g., the pig) for the wavelengths of the target light spectrum by each of the primaries of the lighting device. Next, using for example a set of linear equations solvers, the combination of primaries that produces the same spectral activation of the cone photoreceptors by the device light as the target light spectrum can be determined. In case the first animal is a pig or some other animal with only two types of cone photoreceptors and that cannot see red light or only see red to a small extent, the problem is underdefined. Considering the solutions to the linear equations, the red primary may not be needed, and the lighting device may use only the blue and green primaries in order for the device light to provide the same visual sensation or perception by the first animal as the target light spectrum (e.g., that of a 4000 K black body radiator).

In the context of the present application, the term “spectral response(s)” may be used interchangeably with the term “activation(s)” or “wavelength selective response(s)”.

Further in the context of the present application, by receptors (e.g., first or second receptors) in an eye of an animal (e.g., a first or second animal) it may be meant photoreceptors, or photoreceptor cells in the eye of the animal, which photoreceptors or photoreceptor cells may be in the retina of the eye of the animal. For example, for mammalian eyes, there are three known types of photoreceptor cells: rods, cones, and intrinsically photosensitive retinal ganglion cells. Rod and cone photoreceptors are common to most vertebrates. For invertebrates, most photoreceptors are rhabdomeric instead of ciliary and the complexity and the design of the eye can vary widely, but the embodiments of the present invention can be applied also in such cases. For example, the eyes can be faceted and multiple eye elements or eyes can have different spectral sensitivity. In this case, the sensory activation may be determined by the union of all sensory activations of all photoreceptors in the visual system. According to one or more embodiments of the present invention, a subset of activations may be used for specific applications.

Further in the context of the present application, information (e.g., first or second information) regarding sensitivity of receptors (e.g., first or second receptors) in an eye of an animal (e.g., a first or second animal) in dependency of wavelength may include not only sensitivity of the receptors in the eye of the animal in dependency of wavelength, but may further include at least information regarding optical properties of the eye of the animal, for example including light transmission properties of the eye of the animal, or optical filtering properties of the eye of the animal, e.g., in the sense of optical filtering of incoming light prior to it reaching the visual pigment of the eye. The optical filtering might include the effect of the eye lens, intraocular medium, macula, additional protection eyelids, as well as additional elements in the photoreceptors. For example, in birds, oil droplets with a selective light transmission (which may be referred to as colored oil droplets) may be present in the optical pathway in the photoreceptor cones, via which optical pathway photons may be transported to the photopigments on the retina, which may sharpen the spectral response of the photoreceptor cones. Such oil droplets or another or other types of optical elements which may be present in the eye of an animal may spectrally filter the incoming light before it reaches the visual pigment of the eye. The combination of the spectral filtering of the oil droplet and/or other type of optical element(s) and the optical effect(s) of the visual pigment may substantially attenuate certain wavelengths, or a band of wavelengths, of the incoming light. Information regarding optical properties of the eye of the animal might be referred to as pre-receptoral optical filtering properties or information.

Information regarding sensitivity of receptors in an eye of an animal in dependency of wavelength may for example be or have been determined using optical modelling of the receptors in the eye of the animal, measurements of optical properties of the receptors in the eye of the animal, or a combination thereof. Such modelling and/or measurements are as such known in the art.

Controllability of the lighting device with respect to the light spectrum of the device light can for example be achieved by way of the lighting device comprising at least one wavelength variable light source that is controllable at least with respect to the wavelength of the light emitted by the at least one wavelength variable light source, and with the at least one wavelength variable light source being configured and/or arranged such that the light emitted by the at least one wavelength variable light source constitutes or is comprised in the device light emitted by the lighting device. By the at least one wavelength variable light source being controlled to emit light of one or more selected wavelength ranges, the light spectrum of the device light can be controlled. Wavelength variable light sources are as such known in the art. Other ways of achieving or implementing a lighting device which is controllable with respect to the light spectrum of the light emitted by the lighting device are possible.

As mentioned, the light spectrum of the device light may be controlled such that the spectral responses of the first receptors for the wavelengths of the light spectrum of the device light become the same, or at least comparable to, the spectral responses of the first receptors for the wavelengths of the target light spectrum. By the spectral responses of the first receptors for the wavelengths of the light spectrum of the device light becoming comparable to the spectral responses of the first receptors for the wavelengths of the target light spectrum, it may be meant that the spectral responses of the first receptors for the wavelengths of the light spectrum of the device light are not necessarily exactly the same as the spectral responses of the first receptors for the wavelengths of the target light spectrum, but substantially the same, or (e.g., almost) as close as possible given the capacity or capability of controlling the light spectrum of the device light for the particular lighting device used. That is, in case an exact correspondence between the spectral responses of the first receptors for the wavelengths of the light spectrum of the device light and the spectral responses of the first receptors for the wavelengths of the target light spectrum cannot be achieved given the capacity or capability of controlling the light spectrum of the device light for the particular lighting device used, the light spectrum of the device light may be controlled such that the spectral responses of the first receptors for the wavelengths of the light spectrum of the device light become (e.g., almost) as close as possible the spectral responses of the first receptors for the wavelengths of the target light spectrum. For a non-human animal, very little is known in the art on the method to determine the differences between sensory activation sets. For humans, a number of so-called color difference formulae can be used, such as, for example, CIE ΔE(a*b*), CIE ΔE94, and/or CIE ΔE2000. For non-human animals, two general properties of the visual system can be used. First, the sensitivity to the change of the stimulus depends on the magnitude of the stimulus. A simplified model for this dependence is the Webber-Fechner law, stating that the perceived difference between intensity of a stimulus grows proportionally to the intensity difference divided by the base intensity. Thus, the difference between, e.g., 10 lux and 100 lux is perceptually equal to the difference between 100 lux and 1000 lux. Thus, the differences between the sensory activations are computed on the natural logarithm transform of the computed sensory activation. Second, due to light adaptation, the ratio between the sensory activation of different photoreceptors is more important than the absolute value. Considering both of these two aspects, an example difference measure between two sets of activations may be the L₂ norm of the difference vector between the sensory responses normalized for total photoreceptor activation. For example, if Si⁽¹⁾ is the activation of the i-th photoreceptor (generally, the number of photoreceptors is n) and the sum of the responses of all photoreceptors is [symbol] in the first set, and Si⁽²⁾ is the activation of the i-th photoreceptor and the sum of the responses of all photoreceptors is [symbol] for the second set, dS can be computed as

$$dS = \frac{100}{n} \sqrt{{\sum }_{i = 1}^{n} {( log ( \frac{S {i}^{( 1 )}}{{{S}^{( 1 )}}^{︶}} ) - log ( \frac{S {i}^{( 2 )}}{{{S}^{( 2 )}}^{︶}} ) )}^{2}}$$

By the spectral responses of the (e.g., first) receptors for the wavelengths of the light spectrum of the device light (e.g., a first set of activations) becoming comparable to the spectral responses of the (e.g., first) receptors for the wavelengths of the target light spectrum (e.g., a second set of activations), it may be meant that dS is not exceeding 10, or possibly that dS is not exceeding 15, or possibly that dS is not exceeding 12. Naturally, if there would be no difference between the two sets of activations, dS would be 0.

$$Alternatively , 0 < dS \leq 15 , preferably 0 < dS \leq 12 , more preferably 0 < dS \leq 10.$$

$$Alternatively , 1 < dS \leq 15 , preferably 1 < dS \leq 12 , more preferably 1 < dS \leq 10 .$$

The first information regarding sensitivity of the first receptors in dependency of wavelength may be the sensitivity of the first receptors as a function of wavelength.

The spectral responses of the first receptors for the wavelengths of the target light spectrum may for example be determined by determining a convolution between the target light spectrum and the sensitivity of the first receptors, or perhaps by using some other means for determining a measure of the overlap of the target light spectrum as it is shifted over the sensitivity of the first receptors.

The controlling of the light spectrum of the device light such that the spectral responses of the first receptors for the wavelengths of the light spectrum of the device light become the same, or at least comparable to, the spectral responses of the first receptors for the wavelengths of the target light spectrum, may be carried out under the constraint of one or more first operating limits for the lighting device. The operating limits (e.g., first operating limits) may not necessarily be limits defined by the capacities or capabilities of the lighting device, but may be defined based on desired constraints for operating the lighting device. For example, the operating limits (e.g., first operating limits) may be selected based on (e.g., desired or required) constraints of the total electrical power used by operation of the lighting device or of minimum brightness or dimming level of light emitted by the lighting device.

Possibly, the controlling of the light spectrum of the device light such that the spectral responses of the first receptors for the wavelengths of the light spectrum of the device light become the same, or at least comparable to, the spectral responses of the first receptors for the wavelengths of the target light spectrum, could be carried out under the constraint that one or more operational properties of the lighting device (e.g., total electrical power used by operation of the lighting device) should at the same time be optimized (e.g., minimized).

As described in the foregoing, by means of embodiments of the present invention, it may be facilitated for or allowed to tailor the device light to a non-human animal, or a set of non-human animals. However, it may be advantageous to provide device light that is tailored so as to benefit the vision of the first, non-human animal and another type of animal, which may be of a different species than the first animal, possibly human. One scenario in which this may be relevant is where the first, non-human animal is a livestock animal, and the second animal is a human taking care of the livestock animal.

Thus, according to one or more embodiments of the present invention, based on second information regarding sensitivity of second receptors in an eye of a second animal in dependency of wavelength, spectral responses of the second receptors of the second animal for the wavelengths of the target light spectrum may be determined, with the species of the second animal being different from the species of the first animal. The second animal may for example be human. The controlling of the light spectrum of the device light may further comprise controlling of the light spectrum of the device light such that also spectral responses of the second receptors of the second animal for the wavelengths of the light spectrum of the device light become the same, or at least comparable to, the spectral responses of the second receptors of the second animal for the wavelengths of the target light spectrum.

The second information regarding sensitivity of the second receptors in dependency of wavelength may be the sensitivity of the second receptors as a function of wavelength. The spectral responses of the second receptors for the wavelengths of the target light spectrum may for example be determined by determining a convolution between the target light spectrum and the sensitivity of the second receptors, or perhaps by using some other means for determining a measure of the overlap of the target light spectrum as it is shifted over the sensitivity of the second receptors. In case of humans, the spectral responses can in alternative or additionally be determined by using a colorimeter in which the spectral sensitivities of the human visual system are taken into consideration in the selection of three well-designed filters. Such optical filter approaches are contemplated for the measurement of the spectral power distribution and convolution for other animals too.

The controlling of the light spectrum of the device light such that also spectral responses of the second receptors of the second animal for the wavelengths of the light spectrum of the device light become the same, or at least comparable to, the spectral responses of the second receptors of the second animal for the wavelengths of the target light spectrum, may be carried out under the constraint of one or more second operating limits for the lighting device. As for the first operating limits described in the foregoing, the second operating limits may not necessarily be limits defined by the capacities or capabilities of the lighting device, but may be defined based on desired constraints for operating the lighting device. For example, the second operating limits (e.g., first operating limits) may be selected based on (e.g., desired or required) constraints of the total electrical power used by operation of the lighting device or of minimum brightness or dimming level of light emitted by the lighting device. Possibly, the controlling of the light spectrum of the device light such that also the spectral responses of the second receptors for the wavelengths of the light spectrum of the device light become the same, or at least comparable to, the spectral responses of the second receptors for the wavelengths of the target light spectrum, could be carried out under the constraint that one or more operational properties of the lighting device (e.g., total electrical power used by operation of the lighting device) should at the same time be optimized (e.g., minimized).

The controlling of the light spectrum of the device light such that also spectral responses of the second receptors of the second animal for the wavelengths of the light spectrum of the device light become the same, or at least comparable to, the spectral responses of the second receptors of the second animal for the wavelengths of the target light spectrum, may for example comprise controlling the light spectrum of the device light to include wavelengths in the light spectrum of the device light for which there are no spectral responses of the first receptors of the first animal but for which there are spectral responses of the second receptors of the second animal. The controlling of the light spectrum of the device light, to include wavelengths in the light spectrum of the device light for which there are no spectral responses of the first receptors of the first animal but for which there are spectral responses of the second receptors of the second animal, may for example based on one or more color space-related parameters relating to the second animal, and/or may comprise determining at least one metameric black spectrum of the first receptors of the first animal.

According to one implementation example for illustrating one or more embodiments of the present invention wherein the controlling of the light spectrum of the device light is such that also spectral responses of the second receptors of the second animal for the wavelengths of the light spectrum of the device light become the same, or at least comparable to, the spectral responses of the second receptors of the second animal for the wavelengths of the target light spectrum, the following may be considered. It may be assumed that the first animal is a pig, that the second animal is a human, and that a lighting device (or light source) comprising three primaries (suitably selected as red, green, and blue) is used. As pigs are dichromats, multiple combinations of the primaries will result in the same sensory activation of the pig's photoreceptors. As the light source configuration space is three dimensional and the sensory space is two dimensional, for well selected primaries, the possible solution space is in a sense one dimensional. As such, it can be represented by a point in the lighting device configuration space and a vector in the lighting device configuration space. In the present example, the point can be selected to be the point in the lighting device configuration space that has no power in the red primary. The vector that further defines the line of solutions in the lighting device configuration space can be determined by finding the combination of the primary intensities (at least one of them is necessarily negative) that results in no sensory activation of the photoreceptors of the first animal. As one example for describing principles of one or more embodiments of the present invention, the red primary might have sensory activation (in arbitrary units) of (0, 2), the green of (1, 1), and the blue of (2, 0). In this case, the spectrum that corresponds to the vector (1, −2, 1) in the lighting device configuration space results in no (or substantially no) sensory activation, and it is called a metameric black. Given the line of possible solutions in the light source configuration space, the sensory activation of the photoreceptors of the second animal for all the solutions is determined and the optimal is selected. The optimal in this example is the point in the light source configuration space that corresponds to a spectrum that produces spectral responses of the second receptors for the wavelengths of the light spectrum of the device that are the same, or at least comparable to, the spectral responses of the second receptors for the wavelengths of the target light spectrum. Further, in the one or more embodiments of the present invention illustrated by the implementation example described in the foregoing, it may be switched between different solutions, for example between a solution that is most energy efficient in case there is no human present (e.g., to be illuminated by the device light) and a solution that provides good color representation to humans in case there is a human present. Such switching may for example be based on output from a sensor, which may be configured to sense if a human is present in the vicinity of the lighting device, and/or user input (e.g., by an indication that a human is present which may be provided to the control and processing unit by a user, e.g., via a user interface of the lighting device or control and processing unit or a user interface connected to the lighting device or control and processing unit). As mentioned in the foregoing, according to examples which may be particularly relevant in horticulture, the first animal may be a pollinator, or an animal used or usable for biological pest control. Thus, other example applications relevant for, e.g., the embodiments of the present invention referring to a first and a second animal can be: pollinator guiding light (often containing some ultraviolet (UV) light for an insect) and human observation light; combination of pollinator light (to find and evaluate a flower and its reproductive organs) and pest control insect light (to find the pest organism).

As mentioned, the second animal may be a human. The one or more color space-related parameters relating to the second animal (e.g., a human) may for example comprise one or more parameters derived from one or more device independent color spaces. The one or more parameters derived from one or more device independent color spaces may for example comprise one or more of: correlated color temperature, color rendering index, color quality scale, or one or more points in one or more human centric independent color spaces (e.g., XYZ point(s), xy point(s), or u′v′ point(s)).

The lighting device and the control and processing unit may be considered as separate entities included in the lighting system. However, the control and processing unit may possibly be comprised in the lighting device.

The control and processing unit may for example comprise one or more controllers, control units, control devices, etc., each or any of which for example may include or be constituted by any suitable central processing unit (CPU), microcontroller, digital signal processor (DSP), Application Specific Integrated Circuit (ASIC), Field Programmable Gate Array (FPGA), etc., or any combination thereof. The control and processing unit or one or more controllers, control units, control devices, etc., may optionally be capable of executing software instructions stored in a computer program product, e.g., in the form of a memory. The memory may for example be any combination of read and write memory (RAM) and read only memory (ROM). The memory may comprise persistent storage, which for example can be a magnetic memory, an optical memory, a solid state memory or a remotely mounted memory, or any combination thereof.

The control and processing unit or one or more controllers, control units, control devices, etc., may for example comprise driver circuitry for controlling supply of power to the lighting device and/or for controlling operation of the lighting device and/or any other light generating device which may be comprised in the lighting system. The driver circuitry may for example comprise driver circuitry configured to drive (or control operation of) the lighting device. The control and processing unit or one or more controllers, control units, control devices, etc., may be configured to control operation of the lighting device and/or any other light generating device which may be comprised in the lighting system for example by way of transmitting at least one control signal or control message or the like to the lighting device and/or any other light generating device which may be comprised in the lighting system.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the invention will be described below with reference to the accompanying drawings.

FIG. 1 is a schematic view of a lighting system according to an embodiment of the present invention.

Each of FIGS. 2 and 3 is a schematic flowchart of a method according to an embodiment of the present invention.

All the figures are schematic, not necessarily to scale, and generally only show parts which are necessary in order to elucidate embodiments of the present invention, wherein other parts may be omitted or merely suggested.

### DESCRIPTION WITH REFERENCE TO THE DRAWINGS

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

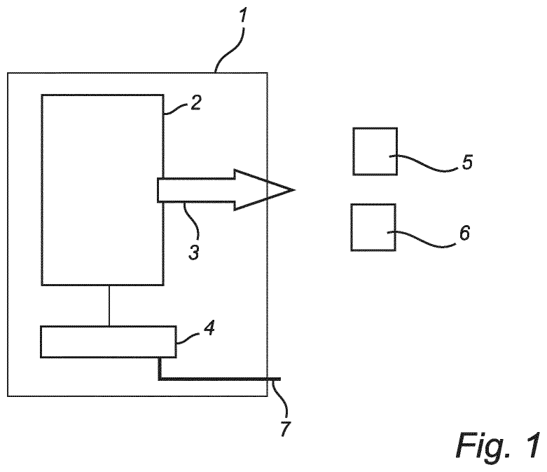

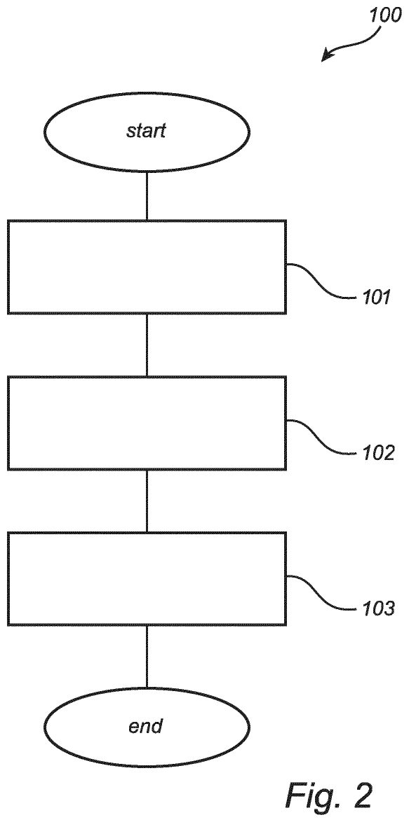

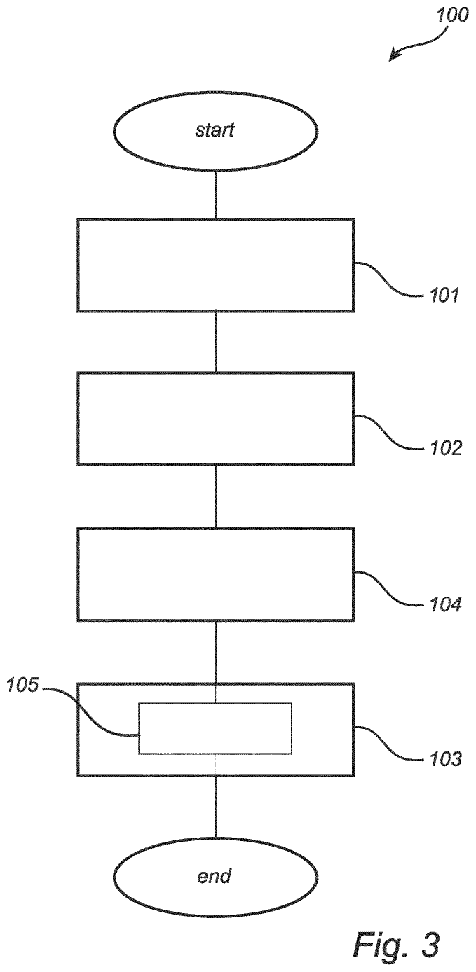

FIG. 1 is a very schematic view of a lighting system 1 according to an embodiment of the present invention.

The lighting system 1 comprises a lighting device 2 configured to emit device light 3 and being controllable at least with respect to the light spectrum of the device light 3. The lighting device 2 may for example comprises at least one wavelength variable light source (not shown in FIG. 1) that is controllable at least with respect to the wavelength of the light emitted by the at least one wavelength variable light source, and with the at least one wavelength variable light source being configured and/or arranged such that the light emitted by the at least one wavelength variable light source constitutes or is comprised in the device light 3. By the at least one wavelength variable light source being controlled to emit light of one or more selected wavelength ranges, the light spectrum of the device light 3 may be controlled.

The lighting system 1 comprises a control and processing unit 4. The control and processing unit 4 is configured to obtain a specification of a target light spectrum. For example, the control and processing unit 4 could be configured to receive or retrieve the specification of the target light spectrum from some entity, schematically indicated at 7 in FIG. 1, which entity 7 may be part of the lighting system 1 or may not be part of the lighting system 1, with the latter possibility being indicated in FIG. 1. Such an entity 7 could for example comprise a database storing specifications of different light spectrums.

The control and processing unit 4 is configured to, based on first information regarding sensitivity of first receptors in an eye of a first animal in dependency of wavelength, determine spectral responses of the first receptors for the wavelengths of the target light spectrum. The first animal, illustrated very schematically by reference numeral 5, is non-human. The first animal 5 may for example be a livestock animal or a household pet. The control and processing unit 4 may for example be preconfigured with such first information, or the control and processing unit 4 could for example be configured to retrieve or receive such first information, e.g., from the entity 7. The entity 7 could for example comprise a user interface, via which a user might provide such first information and/or other information as user input. The entity 7 may for example comprise a database storing the first information, or the user interface may be connected with such a database.

The control and processing unit 4 is configured to control the light spectrum of the device light 3 such that the spectral responses of the first receptors for the wavelengths of the light spectrum of the device light 3 become the same, or at least comparable to, the spectral responses of the first receptors for the wavelengths of the target light spectrum. Thus, the control and processing unit 4 may be configured to control operation of the lighting device 2, at least with respect to the light spectrum of the device light 3. Although FIG. 1 indicates a wired connection between the control and processing unit 4 and the lighting device 2, it is to be understood that the control and processing unit 4 and the lighting device 2 may be connected via one or more wired connections and/or one or more wireless connections, e.g., by way of any appropriate wired and/or wireless connections as known in the art. The control and processing unit 4 may be configured to control operation of the lighting device 2 for example by way of transmitting at least one control signal or control message or the like to the lighting device 2.

The control and processing unit 4 may be configured to, based on second information regarding sensitivity of second receptors in an eye of a second animal in dependency of wavelength, determine spectral responses of the second receptors of the second animal 5 for the wavelengths of the target light spectrum. The species of the second animal, illustrated very schematically by reference numeral 6, is different from the species of the first animal 5. The second animal 6 may for example be human. The control and processing unit 4 may for example be preconfigured with such second information, or the control and processing unit 4 could for example be configured to retrieve or receive such second information, e.g., from the entity 7. As mentioned, the entity 7 could for example comprise a user interface. A user could for example provide such second information and/or other information as user input via the user interface. The entity 7 may for example comprise a database storing the second information, or the user interface may be connected with such a database.

The controlling of the light spectrum of the device light 3 by the control and processing unit 4 may further comprise controlling of the light spectrum of the device light 3 such that also spectral responses of the second receptors of the second animal 6 for the wavelengths of the light spectrum of the device light 3 become the same, or at least comparable to, the spectral responses of the second receptors of the second animal 6 for the wavelengths of the target light spectrum. Thus, the control and processing unit 4 may be configured to control the light spectrum of the device light 3 such that also spectral responses of the second receptors of the second animal 6 for the wavelengths of the light spectrum of the device light 3 become the same, or at least comparable to, the spectral responses of the second receptors of the second animal 6 for the wavelengths of the target light spectrum.

As indicated in FIG. 1, the lighting device 2 may be arranged in relation to the first animal 5 and optionally the second animal 6 so that the device light 3 generally illuminates the first animal 5 and optionally also the second animal 6. According to an example, the first, non-human animal 5 may be a livestock animal, and the second animal 6 may be a human who is taking care of the livestock animal.

FIG. 2 is a schematic flowchart of a method 100 according to an embodiment of the present invention. The method 100 is for controlling a lighting device, the lighting device being configured to emit device light and being controllable at least with respect to the light spectrum of the device light.

The method 100 comprises, at 101, obtaining, a specification of a target light spectrum. At 102, based on first information regarding sensitivity of first receptors in an eye of a first animal in dependency of wavelength, spectral responses of the first receptors for the wavelengths of the target light spectrum are determined. The first animal is non-human. At 103, the light spectrum of the device light is controlled such that the spectral responses of the first receptors for the wavelengths of the light spectrum of the device light become the same, or at least comparable to, the spectral responses of the first receptors for the wavelengths of the target light spectrum. The method 100 may then end.

FIG. 3 is a schematic flowchart of a method 100 according to another embodiment of the present invention. The method 100 illustrated in FIG. 3 includes operations or steps 101, 102 and 103 which are the same or substantially the same as the operations or steps 101, 102 and 103 of the method 100 illustrated in FIG. 2 and described above. In addition to those steps or operations, the method 100 illustrated in FIG. 3 further includes, at 104, based on second information regarding sensitivity of second receptors in an eye of a second animal in dependency of wavelength, determining spectral responses of the second receptors of the second animal for the wavelengths of the target light spectrum, with the species of the second animal being different from the species of the first animal. Possibly, the operation or step 104 may be carried out prior to operation or step 102, and not necessarily afterwards as illustrated in FIG. 3.

Further, in the method 100 illustrated in FIG. 3, the controlling 103 of the light spectrum of the device light further comprises, at 105, controlling the light spectrum of the device light such that also spectral responses of the second receptors of the second animal for the wavelengths of the light spectrum of the device light become the same, or at least comparable to, the spectral responses of the second receptors of the second animal for the wavelengths of the target light spectrum. After the step or operation 103 (including the step or operation 105), the method 100 may end.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for controlling a lighting device, the lighting device being configured to emit device light and being controllable at least with respect to the light spectrum of the device light, the method comprising:
obtaining a specification of a target light spectrum;
based on first information regarding the spectral sensitivity of first receptors in an eye of a first animal as a function of wavelength, determining spectral responses of the first receptors for the wavelengths of the target light spectrum by determining a convolution between the target light spectrum and the spectral sensitivity of the first receptors, wherein the spectral sensitivity of first receptors in an eye of the first animal as a function of wavelength is different from the spectral sensitive of receptors in an eye of a human; and
controlling the light spectrum of the device light such that the determined spectral responses of the first receptors for the wavelengths of the light spectrum of the device light by determining a convolution between the light spectrum of the device light and the spectral sensitivity of the first receptors become the same, or at least comparable to, the determined spectral responses of the first receptors for the wavelengths of the target light spectrum, wherein controlling the light spectrum of the device light comprises minimizing the calculated difference between the determined spectral responses of the first receptors for the wavelengths of the light spectrum of the device light and the determined spectral responses of the first receptors for the wavelengths of the target light spectrum below a specified threshold value.

2. A method according to claim 1, wherein the spectral responses of the first receptors for the wavelengths of the target light spectrum are determined by determining a convolution between the target light spectrum and the sensitivity of the first receptors.

3. A method according to claim 1, the method further comprising:
determining a control signal based on said calculated minimized difference, and wherein the control signal is used to control the lighting device for generating the determined light spectrum that provides said calculated minimized difference between the determined spectral responses of the first receptors for the wavelengths of the light spectrum of the device light and the determined spectral responses of the first receptors for the wavelengths of the target light spectrum.

4. A method according to claim 1, wherein the controlling of the light spectrum of the device light such that the spectral responses of the first receptors for the wavelengths of the light spectrum of the device light become the same, or at least comparable to, the spectral responses of the first receptors for the wavelengths of the target light spectrum, is carried out under the constraint of one or more first operating limits for the lighting device.

5. A method according to claim 1, further comprising:
based on second information regarding the spectral sensitivity of second receptors in an eye of a second animal as a function of wavelength, determining, spectral responses of the second receptors of the second animal for the wavelengths of the target light spectrum by determining a convolution between the target light spectrum and the sensitivity of the second receptors, the species of the second animal being different from the species of the first animal, wherein the second information regarding the spectral sensitivity of second receptors in an eye of a second animal as a function of wavelength is different from the first information regarding the spectral sensitivity of first receptors in an eye of a first animal as a function of wavelength;
wherein the controlling of the light spectrum of the device light further comprises controlling (105) of the light spectrum of the device light such that also determined spectral responses of the second receptors of the second animal for the wavelengths of the light spectrum of the device light become the same, or at least comparable to, the determined spectral responses of the second receptors of the second animal for the wavelengths of the target light spectrum.

6. A method according to claim 5, wherein the controlling of the light spectrum of the device light such that also spectral responses of the second receptors of the second animal for the wavelengths of the light spectrum of the device light become the same, or at least comparable to, the spectral responses of the second receptors of the second animal for the wavelengths of the target light spectrum, is carried out under the constraint of one or more second operating limits for the lighting device.

7. A method according to claim 5, wherein the controlling of the light spectrum of the device light such that also spectral responses of the second receptors of the second animal for the wavelengths of the light spectrum of the device light become the same, or at least comparable to, the spectral responses of the second receptors of the second animal for the wavelengths of the target light spectrum, comprises:
controlling the light spectrum of the device light to include wavelengths in the light spectrum of the device light for which there are no spectral responses of the first receptors of the first animal but for which there are spectral responses of the second receptors of the second animal.

8. A method according to claim 7, wherein the controlling of the light spectrum of the device light, to include wavelengths in the light spectrum of the device light for which there are no spectral responses of the first receptors of the first animal but for which there are spectral responses of the second receptors of the second animal, is based on one or more color space-related parameters relating to the second animal.

9. A method according to claim 7, wherein the controlling of the light spectrum of the device light, to include wavelengths in the light spectrum of the device light for which there are no spectral responses of the first receptors of the first animal but for which there are spectral responses of the second receptors of the second animal, comprises determining at least one metameric black spectrum of the first receptors of the first animal.

10. A method according to claim 8, wherein the second animal is a human, and the one or more color space-related parameters relating to the second animal comprise one or more parameters derived from one or more device independent color spaces.

11. A method according to claim 10, wherein the one or more parameters derived from one or more device independent color spaces comprise one or more of: correlated color temperature, color rendering index, color quality scale, or one or more points in one or more human centric independent color spaces.

12. A method according to claim 5, wherein the second animal is a human.

13. A lighting system comprising:
a lighting device configured to emit device light and being controllable at least with respect to the light spectrum of the device light; and
a control and processing unit configured to:
obtain a specification of a target light spectrum;
based on first information regarding the spectral sensitivity of first receptors in an eye of a first animal (5) as a function of wavelength, determine spectral responses of the first receptors for the wavelengths of the target light spectrum by determining a convolution between the target light spectrum and the spectral sensitivity of the first receptors, wherein the spectral sensitivity of first receptors in an eye of the first animal as a function of wavelength is different from the spectral sensitive of receptors in an eye of a human; and
control the light spectrum of the device light such that the determined spectral responses of the first receptors for the wavelengths of the light spectrum of the device light determining by a convolution between the light spectrum of the device light and the spectral sensitivity of the first receptors become the same, or at least comparable to, the determined spectral responses of the first receptors for the wavelengths of the target light spectrum, wherein controlling the light spectrum of the device light comprises minimizing the calculated difference between the determined spectral responses of the first receptors for the wavelengths of the light spectrum of the device light and the determined spectral responses of the first receptors for the wavelengths of the target light spectrum below a specified threshold value.

14. A lighting system according to claim 13, wherein the first animal is a livestock animal or a household pet.

15. A non-transitory computer readable medium comprising instructions which, when executed by one or more processors of a control and processing unit of a lighting system, cause the control and processing unit to perform the method according to claim 1.
